(19) United States
(12) Patent Application Publication
(10) Pub. No.: US 2022/0164834 A1
(43) Pub. Date: May 26, 2022

(54) COMPUTERIZED SYSTEMS AND MEHTODS FOR MANAGING CROWDFUNDING CAMPAIGNS

(71) Applicant: ANGELINK, INC., Naples, FL (US)

(72) Inventors: Gerry M. Poirier, Naples, FL (US); Jason W. Botts, Raleigh, NC (US); Robert J. Poirier, Naples, FL (US)

(21) Appl. No.: 17/666,865

(22) Filed: Feb. 8, 2022

Related U.S. Application Data
(62) Division of application No. 16/819,554, filed on Mar. 16, 2020.
(60) Provisional application No. 62/819,425, filed on Mar. 15, 2019.

(51) Int. Cl. G06Q 30/02

(52) U.S. Cl. CPC G06Q 30/0279; G06Q 30/0282

(57) ABSTRACT

Embodiments of the present disclosure include computer-implemented systems and methods for managing fundraising and crowdfunding campaigns. A method of managing a fundraising campaign may include launching a first fundraising campaign, determining, by a computer-implemented algorithm, a surplus amount of monetary donation, identifying a plurality of fundraising campaigns, each fundraising campaign of the plurality of a different set of fundraising campaigns comprising a second plurality of characteristics, wherein at least one characteristic of the first and the second plurality of characteristics is similar; determining a portion of the surplus amount to be distributed to the identified plurality of fundraising campaigns, the portion based on a pro-rata distribution mechanism, and generating a recommendation for a donor. Other methods of incentivizing raising donations and donating for a fundraising campaign or a crowdfunding campaign are also discussed.

### BACKGROUND

### Field of the Invention

The present disclosure generally relates to computerized systems and methods for managing crowdfunding campaigns. In particular, embodiments of the present disclosure relate to inventive and unconventional computerized systems and methods, and user interfaces for distributing funds evenly for charitable campaigns with similar objectives, and schemes to incentivize donor and fundraiser engagement.

### Discussion of the Background

Crowdfunding is the practice of raising monetary contributions for commercial or non-commercial causes by soliciting a group of people. Multiple crowdfunding and fundraising platforms have emerged over the years. However, currently existing crowdfunding platforms, face technical challenges in the area of funds balancing and fraud prevention.

Specifically, some campaigns may be more effective and may over-accomplish their fundraising goals, while the others may fall short of their goals. This creates an imbalance in the raised funds for campaigns with similar objectives and characteristics, and the desired level of help may not be generated evenly.

In addition, donors and campaign organizers are not vetted for authenticity. For example, the campaign organizer may be untruthful about the cause for the campaign, or the donors may use such campaigns for misappropriation of funds, which may lead to unintended consequences.

Therefore, there is a need to address the challenges in managing fundraising and crowdfunding campaigns such that the platforms are fair, trustworthy, engaging, and efficient in accomplishing fundraising goals.

Furthermore, other desirable features and characteristics will become apparent from the subsequent detailed description and the appended claims, taken in conjunction with the accompanying drawings and this background of the disclosure.

### BRIEF SUMMARY OF THE INVENTION

One aspect of the present disclosure is directed to a method for managing a fundraising campaign. The method may comprise launching a first fundraising campaign comprising a first plurality of characteristics, determining, by a computer-implemented algorithm, a surplus amount of monetary donation towards the first fundraising campaign based on a monetary goal associated with the fundraising campaign. The method may further comprise identifying, by the computer-implemented algorithm, a plurality of a different set of fundraising campaigns, each fundraising campaign of the plurality of the different set of fundraising campaigns comprising a second plurality of characteristics, wherein at least one characteristic of the first and the second plurality of characteristics is similar. The method may further comprise upon identifying, determining, by the computer-implemented algorithm, a portion of the surplus amount to be distributed to the identified plurality of the different set of fundraising campaigns, the portion based on a pro-rata distribution mechanism. The method may further comprise generating, by the computer-implemented algorithm, a recommendation for a donor to the first fundraising campaign, to donate to one or more of the identified plurality of the different set of fundraising campaigns based on the determination of the portion of the surplus amount, and sending, by the computer-implemented algorithm, instructions to a user-device to cause the user-device to display the recommendation and a donation request notification for the donor.

Another aspect of the present disclosure is directed to a method for incentivizing raising donation for a fundraising campaign. The method may include launching using a computer-implemented algorithm, a fundraising campaign comprising a plurality of characteristics based on an input from a campaign organizer, and determining, by the computer-implemented algorithm, a monetary goal for the fundraising campaign based on the plurality of characteristics. The method may further comprise sending, by the computer-implemented algorithm, to a user-device for display, a first indication of a receipt of a first reward for launching the fundraising campaign. The method may also include sending, by the computer-implemented algorithm, to the user-device for display, a notification of a receipt of a donation from a donor, the notification comprising information associated with the donation, determining, by the computer-implemented algorithm, a percentage of the monetary goal accomplished based on the received donation, sending, by the computer-implemented algorithm, to the user-device for display, a second indication of a receipt of a second reward upon accomplishing a first percentage of the monetary goal, and sending, by the computer-implemented algorithm, to the user-device for display, a third indication of a receipt of a third reward upon accomplishing the monetary goal.

Another aspect of the present disclosure is directed to a method for incentivizing donating for a fundraising campaign. The method may comprise identifying, by a computer-implemented algorithm, a fundraising campaign based on a donor input, processing, by the computer-implemented algorithm, information associated with the donor input to validate a donor, upon validating, sending, by the computer-implemented algorithm, to a user-device for display, a notification to grant access to the validated donor to donate to the identified fundraising campaign, processing, by the computer-implemented algorithm, a first monetary donation received from the donor, wherein the processing comprises updating, in real-time, a percentage completion value of a monetary goal of the fundraising campaign, sending, by the computer-implemented algorithm, to a user-device for display, a first indication of a receipt of a first reward based on the first monetary donation, and sending, by the computer-implemented algorithm, to a user-device for display, a second indication of a receipt of a second reward based on the second monetary donation.

Other advantages of the embodiments of the present disclosure will become apparent from the following description taken in conjunction with the accompanying drawings wherein are set forth, by way of illustration and example, certain embodiments of the present disclosure.

### BRIEF DESCRIPTION OF THE DRAWINGS

FIG. 1 is a schematic illustration of an exemplary process flowchart for trusted connection method, consistent with disclosed embodiments.

FIG. 2 is a schematic illustration of an exemplary process flowchart for trusted funding method, consistent with disclosed embodiments.

FIG. 3 is a schematic illustration of an exemplary method for distributing excess campaign funds, consistent with disclosed embodiments.

FIG. 4 is a schematic illustration of an exemplary fraud prevention method, consistent with disclosed embodiments.

FIG. 5 is a schematic illustration of an exemplary art asset in the donor engagement tool, consistent with disclosed embodiments.

FIG. 6 is a schematic illustration of an exemplary art asset in the donor engagement tool, consistent with disclosed embodiments.

FIG. 7 is a schematic illustration depicting tiers of donor engagement in an exemplary donor engagement tool, consistent with disclosed embodiments.

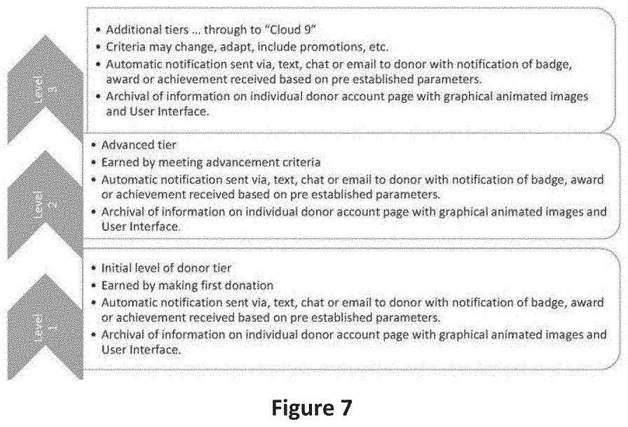

FIG. 8 is a schematic illustration of an exemplary art asset for displaying incoming donations in the campaign organizer engagement tool, consistent with disclosed embodiments.

FIG. 9 is a schematic illustration of an exemplary art asset in the campaign organizer engagement tool, consistent with disclosed embodiments.

FIG. 10 is a schematic illustration of an exemplary visualization depicting growth of a campaign in the campaign organizer engagement tool, consistent with disclosed embodiments.

FIG. 11 is a schematic illustration of customizable and non-animated art assets, consistent with disclosed embodiments.

FIG. 12 is a schematic illustration of customizable and animated art assets, consistent with disclosed embodiments.

FIG. 13 is a schematic illustration of an exemplary process flow for donor-campaign organizer engagement, consistent with disclosed embodiments.

FIG. 14 is a schematic illustration of an exemplary donor engagement art asset, consistent with disclosed embodiments.

FIG. 15 is a schematic illustration of exemplary art assets for displaying incoming donations and donor engagement in the campaign organizer engagement tool, consistent with disclosed embodiments.

FIG. 16 is a schematic illustration of exemplary art assets, consistent with disclosed embodiments.

FIG. 17 is a schematic illustration of exemplary art assets, consistent with disclosed embodiments.

FIG. 18 is a schematic illustration of exemplary art assets, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C. Embodiments of the present disclosure are directed to systems and methods configured for managing crowdfunding and fundraising campaigns.

A. Trusted Vs Non-Trusted Campaign Organizer—Donor Decides how his/her Donation (in Excess of a Campaign's Financial Goal) Will be Distributed on the Platform

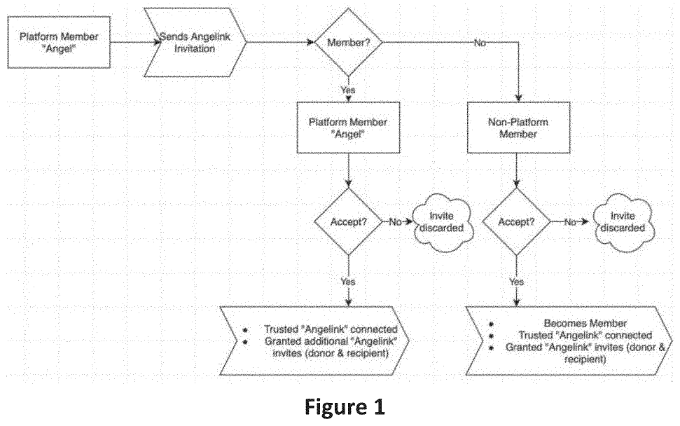

Reference is now made to FIG. 1, which illustrates an exemplary trusted connection method, consistent with disclosed embodiments. A platform member, as referred to herein, may include, but is not limited to, a campaign donor, a campaign organizer, a campaign manager, a campaign member, or a campaign user. The trusted connection method may enable the donor at the time of donation to indicate if the campaign organizer is a “trusted” friend or a known contact (“Angelinks”). The campaign organizer may be an “unknown” contact such as, for example, a person that the donor does not know on a personal basis, or is not a personal friend, or has no personal connection with.

In some embodiments, the trusted contact or the trusted connection may be archived in the both the campaign organizer's as well as the donor's account page through the use of a data set so that the algorithm may archive how many trusted friends or personal friends have donated to a particular campaign. In some embodiments, the algorithm may be configured to archive the number of donations made by a donor to “trusted” friends, or individuals that the donor does not know personally. In some embodiments, the algorithm may archive and maintain records so that both campaign organizers and donors may access information associated with their individual “trusted” networks.

FIG. 1 illustrates one implementation of the trusted connection method. For example, a platform member such as a trusted donor, a campaign organizer, a campaign manager, etc. may send an Angelink invitation to a platform user. Once the recipient of the invitation is verified as a platform member or becomes a platform member, the system may identify the member as trusted.

In some embodiments, the trusted connection method may comprise determining the relationship between a donor and a campaign organizer by, for example, other trusted connections verifying the relationship, demonstrating a trusted relationship through multiple shared campaign donations, the duration of connection demonstrated, or some other means. Once established, the algorithm may be configured to determine and categorize the relationship between donor and campaign organizer as trusted. In some embodiments, a trusted contact or a trusted connection may comprise a friend, a family member, a neighbor, an association, a co-worker, or any person indicated by the donor as a “trusted” contact.

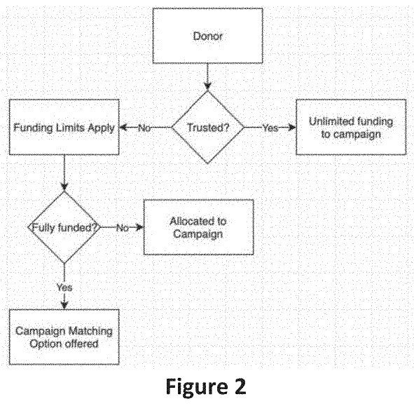

Reference is now made to FIG. 2, which illustrates an exemplary trusted funding method, consistent with disclosed embodiments. Upon indication by the donor making donations to a campaign that the relationship between the donor and the campaign organizer is trusted, the algorithm may be configured to connect the donor and the campaign organizer. The algorithm may add the campaign organizer to the donors' “Trusted Community.”

In some embodiments, as illustrated in FIG. 2, upon determination and verification that the relationship between the donor and the campaign organizer is trusted, the algorithm may allow unlimited funds to be contributed by the donor to any campaign organized by the trusted campaign organizer.

In some embodiments, as illustrated in FIG. 2, the donor may not identity the relationship with the campaign organizer and indicate the relationship as an “unknown” relationship. An unknown relationship may include, but is not limited to, an untrusted, an unknown, or an unwilling relationship. In response to determining an unknown relationship, the algorithm may be configured to interpret that the donor does not personally know or has no personal connection with the campaign organizer. In such cases, the algorithm may be configured to flag the donation and may further notify the donor if the campaign organizer has exceeded their fundraising goal or if a part or all of their donation will make this campaign exceed its goal.

In some embodiments, the donor may be notified that they have the option to give the unknown campaign organizer their full donation amount. The campaign organizer may launch a campaign that does not directly benefit a registered 501(c)(3) charity, for example. Additionally, or alternatively, if the campaign is overfunded or some other funding limit applies, the donor may be requested to distribute donated funds to other similar campaigns. Distributing excess donation funds to eligible similar campaigns may be referred to as the “Split Gift” donation distribution method. In some embodiments, the algorithm may be configured to determine the method of donation distribution. Similarity between campaigns may be determined based on a comparison of one or more campaign characteristics.

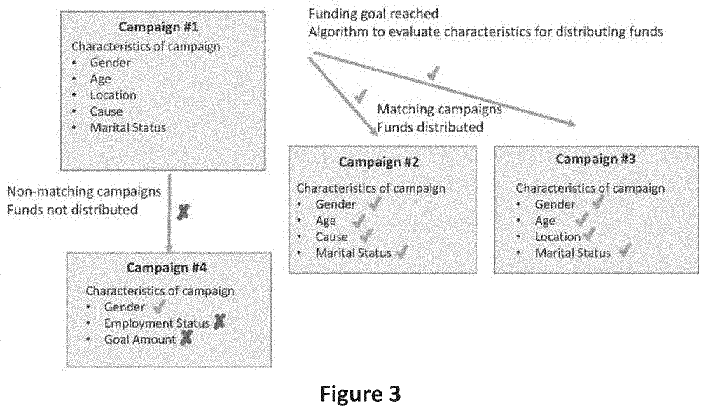

Referring to FIG. 3, which illustrates an exemplary campaign distribution method, in some embodiments the donor may choose the option “Select Others.” (not pictured). In response to the selection, the algorithm may be configured to perform additional analysis to create a list of matching campaigns that may have at least one or more similar characteristics including, but not limited to, gender, age, location, employment status, marital status, cause, category, region, need, or other proprietary characteristics. In some embodiments, the characteristics of a campaign may be predetermined, for example, by a campaign organizer, a campaign manager, or the like.

In some embodiments, a computer-implemented method for managing a fundraising campaign may comprise launching a first fundraising campaign comprising a first plurality of characteristics. The fundraising campaign may be launched on a platform including, but is not limited to, a website, a mobile phone application, or other relevant launch platforms. The fundraising campaign may be initiated by a campaign organizer, a fundraiser, a campaign manager, a volunteer, or the like. In some embodiments, the campaign organizer or the fundraiser may be the beneficiary of the fundraising campaign. In some embodiments, in the case of a fundraising or a crowdfunding campaign, an individual or a group of individuals may be the designated beneficiaries.

The method of managing the fundraising campaign may further include determining, by a computer-implemented algorithm, a surplus amount of monetary donation towards the first fundraising campaign based on a monetary goal associated with the fundraising campaign. In some embodiments, the campaign organizer or the fundraiser may provide input associated with the fundraising campaign information. The input information may include, for example, the gender, marital status, medical condition, financial status, location, among other things. For example, the fundraising campaign may be intended to raise money for the treatment of ulcerative colitis for Jane, a single, unemployed mom in Richmond, Va. In such a scenario, the algorithm may be configured to determine a monetary goal associated with the fundraising campaign, considering the cost of medical treatment in hospitals in Richmond, Va., cost of day-care facilities for her kid(s), accommodation costs, and the like. The algorithm may further be configured to determine a surplus amount raised based on the determined monetary goal.

The method of managing the fundraising campaign may further include identifying, by the computer-implemented algorithm, a plurality of fundraising campaigns, each fundraising campaign of the plurality of fundraising campaigns comprising a second plurality of characteristics, wherein at least one characteristic of the first and the second plurality of characteristics is similar. The algorithm may be further configured to identify other fundraising campaigns having one or more characteristics similar to the fundraising campaign that has surpassed its fundraising goal. The identification of other fundraising campaigns may be based on a first layer of similarities including a cause of donation and the location. For example, the algorithm may be configured to identify fundraising campaigns for beneficiaries with ulcerative colitis in Richmond, Va. The algorithm may identify such campaigns as “similar” in characteristics and tag them as potential recipients of donations from distribution of the surplus amount from Jane's fundraising campaign.

The method may further include, upon identifying, determining, by the computer-implemented algorithm, a portion of the surplus amount to be distributed to the identified plurality of fundraising campaigns, the portion based on a pro-rata distribution mechanism. As referred to herein, pro-rata refers to a donation contribution based on a predetermined percentage. For example, from an available fund value of $100, and a minimum amount of $5 per campaign, the algorithm may allocate a maximum of 20 matched fundraising campaigns based on a first category of data matching characteristics. In some embodiments, the surplus funds may be distributed evenly among the identified campaigns.

A second layer within the algorithm would further refine the data matching factors to expand and therefore further refine data matching to add another level of granularity to the matching based on a narrower filter. For example, a medical category match will be further split into types of illness, such as cancer, heart disease, cardiac stroke, etc. so that a closer match can be achieved with a reduced number of campaign matches to ensure that the $100 donation is not split among 100 campaigns, thus initiating only a $1 donation per campaign which is below the minimum threshold but rather that the $100 donation is split among no more than 20 campaigns to ensure the $5 minimum threshold amount is donated to each campaign that is matched by the algorithm.

The method may further include generating, by the computer-implemented algorithm, a recommendation for a donor to the first fundraising campaign, to donate to one or more of the identified plurality of fundraising campaigns based on the determination of the portion of the surplus amount. The donor may be notified, using a user-device, about an opportunity to split the gift or donation to similar fundraising campaigns. The user-device may include, but is not limited to, a mobile phone, a computer, a tablet, a laptop, a hand-held audio-visual device, and the like. The user-device may be configured to display and receive user input, and communicate the user input to a processor configured to execute the algorithm.

The method may further include sending, by the computer-implemented algorithm, instructions to a user-device to cause the user-device to display the recommendation and a donation request notification to the donor.

In some embodiments, characteristics of a campaign for data matching may include a cause for donation, a location of a beneficiary, or a beneficiary profile. Causes for donation may include, but are not limited to, medical, memorial, emergency, education, volunteer, charity, teams and sports, pets and animals, faith, friends and family or community, and the like. In some embodiments, data matching may be created so that a minimum amount of funds, such as $5, for example, may be derived from the aggregate donation input so that a $100 donation would be split on a pro-rata basis.

In some embodiments, the algorithm may create a list of characteristics based on one or more factors including relevance, urgency, crisis, risk, etc. for each campaign. The algorithm may further arrange the characteristics in an order based on predetermined factors such as relevance, urgency, amount of fundraising needed, or the like. In some embodiments, the algorithm may comprise a computer-implemented software program, a mathematical algorithm, an artificial intelligence algorithm, deep learning algorithm, or neural network processing.

In some embodiments, input data to the algorithm may include, but are not limited to, daily percentage completion of funding goal, daily funding velocity (a proprietary measure of the rate of donations through volume, total amount and/or frequency metrics), organizer demographics such as, for example, age, gender, and physical location. The algorithm may be configured to utilize the input data to create a comparative metric with key parameters to establish distinguishing characteristics and/or features of the initial campaign. The distinguishing characteristics may be used to create a specific combination of data points, a profile, or a “fingerprint” per se of the campaign.

In some embodiments, the algorithm may be configured to calculate and/or recommend a pool of campaigns based on the fingerprint of the original campaign. The algorithm may rank a campaign using a scoring mechanism to recommend other campaigns to match as potential recipients of distribution of excess funds. The excess funds may be distributed to one or more campaigns which are matched with the initial campaign based on a method that combines data identified for this purpose.

In some embodiments, a computer-implemented system may use database calculations, including using one or more specific characteristics of each campaign to find similar campaigns. In the context of this disclosure, a similar campaign refers to a campaign, for example, with a similar cause-related objective. Other characteristics may be included to determine similarities between campaigns. The computer-implemented system may analyze one or more metrics and characteristics to determine the percentage of the funding goal attained. Based on the determination, the computer-implemented system may recommend a match to another campaign identified in the fingerprinting process. The algorithm may programmatically recommend or identify other campaigns with the same fingerprint up to a calculated maximum percentage and/or for a certain maximum time period. The computer-implemented system may also seek to boost the largest number of campaigns to achieve successful conclusion of their goals and/or distribute funds to the greatest number of campaigns depending on data A computer-implemented system may comprise a memory storing instructions, a processor configured to execute the stored instructions, a network, a database, a display device, a user-interface device, etc. It is appreciated that the computer-implemented system may include other relevant components as well.

In some embodiments, the donor may choose if he/she wants to continue to give their donation to the original campaign organizer (who has already exceeded their funding request), or if they prefer to split-gift their donation to the pre-determined group of campaigns that have been automatically matched by data sets as described above for this group of campaigns who have not yet reached their campaign goals. As an example, the algorithm may identify, flag and/or tag the campaign once it reaches 100% of its fundraising goal. The algorithm may begin the process of matching these excess funds through the methods set forth in the algorithm noted above to complete the calculation of funds for distribution to other personal campaigns matched with initial campaign. The campaigns may be matched, by an algorithm, based on the method of matching characteristics as described above. In some embodiments, data security and encryption techniques such as blockchain technology may be employed to provide an immutable record for each campaign, campaign organizer, transaction and/or platform member.

An illustrative example of trusted connection and funding method is described herein. A young woman named Susan from Maryland (who is an “unknown” campaign organizer) may establish a personal fundraising campaign on the platform to pay for $10,000 in medical bills that she cannot afford as a result of suffering from breast cancer. At some point, she surpasses the $10K goal. A donor with a $90 donation, who has indicated Susan as an unknown, may be given an option to review other campaigns launched by Mary, Jane and Beth who live in Maryland, Virginia or Washington D.C. who at the time of the donation are the only 3 campaigns matched by the algorithm that share the same characteristics of category and location or zip code match so that these 3 campaigns will each receive an equal distribution of the donor's $90 donation or $30 each. These campaigns may be matched due to the pre-determined category of cancer and/or sub-category of “breast cancer,” respectively, who also have breast cancer as well as bills of approximately $10K, and other similar characteristics. Mary, Jane, and Beth have not been as lucky as Susan and have not yet reached their fundraising goals. The donor may be requested to choose to either continue to give their $90 donation to Susan or the donor can decide to “Split Gift” their donation and give the $90 donation to pre-determined group that includes the campaigns of these 3 women who have been data matched due to the similar category and surrounding zip code that includes campaigns launched by Mary, Jane or Beth to help one of these other women to derive a $30 donation instead.

B. Fraud Protection

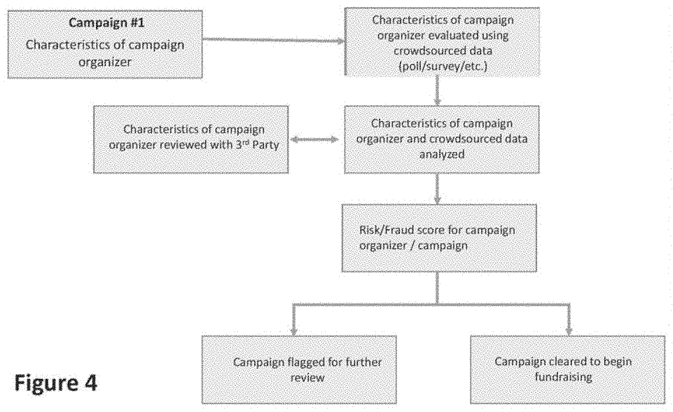

Reference is now made to FIG. 4, which illustrates an exemplary fraud prevention method, consistent with disclosed embodiments. The fraud prevention method may comprise validating personal, group and/or charitable fundraising campaigns launched on a crowdfunding platform to provide an enhanced level of protection against potential fraud. This method may use computer-implemented systems for mapping a campaign organizer's past behavior for fraud through a combined analysis of prior platform activities, crowdsourced rating algorithms as well as protected, private data query communications. The computer-implemented system, using an algorithm, may be configured to connect one or more databases (including third-party systems) to generate a fraud risk score for a campaign. The campaign fraud risk score may be represented as a number on a scale of 1 to 10, or as a category comprising low/medium/high, as a color on a color-coding scheme, etc. Other score representations may be used as well. The algorithm may be configured to review data parameters, create comparative metrics based on one or more reviewed parameters, and establish distinguishing characteristics and/or features of the campaign. The algorithm may be further configured to create a unique combination of data points with a series of flags and/or data exchange. The algorithm may be further configured to receive feedback from one or more of the sources as inputs to determine if the campaign suggests additional scrutiny and/or validation as a result of matched data combinations.

In some embodiments, a campaign organizer or a campaign user may be notified that campaigns may be reviewed for fraud prevention, based on predetermined terms of service and user agreement. In some embodiments, the algorithm may be configured to identify campaigns to be reviewed for fraud risks based on a predetermined set of factors, including but not limited to, dollar value of the fundraising goal, location of the campaign, a repetitive theme or an event, etc. These values or levels may be derived, for example, to create a system that flags preidentified items that are prepopulated as potential areas of concern.

In some embodiments, computer-implemented system may be configured to generate a fraud risk score for each campaign organizer using a computer-based algorithm. The algorithm may be configured to obtain and utilize data from the campaign organizer to determine the campaign organizer fraud risk score. The determination of the campaign organizer fraud risk score may include, but is not limited to, information associated with background checks, criminal proceedings, court actions, property records, tax records, current address, previous known addresses, judgements and liens, bankruptcies, real property assets, marriage and divorce records, date of birth records, jobs and education, traffic and drunk driving reports and other relevant data.

In some embodiments, campaign organizer data may be paired with other data such as family and immediate relations information, neighbors, associations and family member information, social media account information and postings as well as photographs from social media networks. In some embodiments, data from various third-party background checks and credit check systems may be integrated in order to derive specific characteristics.

In some embodiments, the computer-implemented system may rate other on-line campaign or fundraising activities using a rating or polling mechanism. The rating mechanism may be based on a comparison of available information associated with at least one of a campaign or a campaign organizer. The rating may enable a platform member to determine potential areas of concern for personal, group and/or charitable fundraisings campaigns. Organizer's activities on the platform, including campaign frequency, frequency of trusted connections, changes to trusted relationships, activities of trusted relationships, campaign success rate, funding velocity, contributions and other patterns of activity using the platform, among other things, may also be factored into determining the fraud risk score. Additional datasets may be implemented to validate a campaign organizer such as uploading documents in order to establish proof of need, and to validate the cause of the campaign organizer when the campaign is to directly benefit the campaign organizer or another person or entity that is not a properly registered and 501(c)(3) organization. To validate a campaign, additional data fields may be desired after the campaign is established on the platform to validate and establish proof of need such as the following driver's license, passport or government issued identification medical bills, home repair bills, student loan bills, veterinary bills, certificate of death and/or memorial expense bills etc.

For example, related to the platform's “Angelinks” connections, if a campaign organizer has a high number of trusted connections and those connections have had multiple successful campaigns, that donor may have an elevated score (higher scores are better). If, however, a campaign organizer has trusted connections with campaigns that have been flagged as risky, this may impact their own fraud risk score negatively. The platform may provide a rating system to capture items and build a history of behavior or connection links between data points that could be predictive of fraudulent activity or potentially fraudulent. The system may create one or more alerts which may be fed back to the platform and establish a structured process to review flagged items.

In some embodiments, a detailed formulaic review process may be created to inform the campaign organizer that further valuation may be desired or that there are potential issues that may need to be addressed to further validate the campaign. Information including personal activities, background data, marital records, education background information, etc. may be collected through encrypted data communication between the platform and data providing entities such as credit agencies, credit bureaus, reputational authorities, crowdsourced data from 3rd party solutions and various other data repositories. Information may be transmitted over the Internet and stored in an encrypted format in a tokenized manner such that information is not linked using personally identifiable information. In some embodiments, data may only be utilized to establish a fraud risk score and may be deleted from the system once the determination is complete. In some embodiments, data security and encryption techniques such as blockchain technology may be employed to provide an immutable record for each campaign, campaign organizer, transaction and/or platform member.

In some embodiments, the fraud risk score may be updated based on updated data obtained from time to time. The algorithm may use the updated data as input data to determine the updated fraud risk score based on the updated information.

As an example, the fraud risk scoring system may be based on a scale of 0 to 1000 with higher scores being more favorable to lower scores. Campaigns may begin with a predetermined initial score of 100 with additional information allowing for the campaign organizer to improve their score, as well as the score of the campaign itself. With additional positive information collected using the computer-based processes above, the algorithm may advance the score towards 1000 or deduct points further towards zero. In some embodiments, the rating system may have risk levels and thresholds that may be adjusted over time. To validate a campaign additional data fields may be desired after the campaign is established on the platform to validate and establish proof of need. For example, after David organizes a campaign on the platform and indicates his roof blew off in a recent hurricane and he needs to raise $20,000 for a new roof, the algorithm may be configured to send instructions, to a campaign manager, for example, contact David upon a certain percentage of fundraisings has been attained that prompts David to upload into the platform's database a copy of a mortgage statement or deed to his home that indicates he is the rightful owner of the property as well his driver's license that also can serve as a photographic record of David's images as well as his physical address as validation that David address on his driver's license and physical address of the house depicted in the campaign are at the same location as the matched data David input in his campaign organization. The algorithm will then assign a validation match to David's campaign on the platform and alert the system that David's campaign has been approved for withdrawals per the dataset recorded for disbursement of funds as defined per the pre-set additional logic embedded in the platform.

C. Campaign Donor Engagement

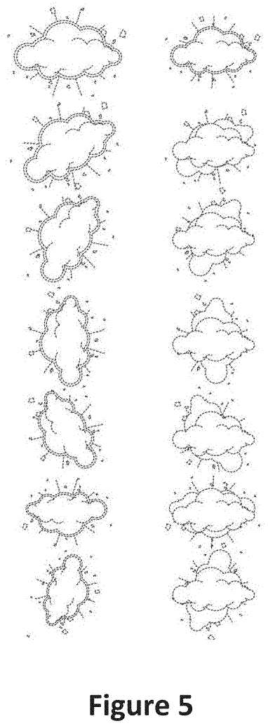

Reference is now made to FIG. 5, which illustrates an exemplary donor engagement mechanism, consistent with disclosed embodiments. The donor engagement mechanism may include a technology-based solution that incentivizes donors to participate in giving and/or to increase their contributions to crowdfunding campaigns, for example, by either giving multiple donations to a single campaign, or donating money to multiple campaigns.

In some embodiments, the donor engagement mechanism may interface with social media networking sites to correlate existing donors with potential donors by populating a micro-community of friends, family and likeminded connections. The method of engaging and encouraging more donors may comprise making recommendations, based on an algorithm, by predicting an increased likelihood of giving.

In some embodiments, the algorithm may identify other similar contacts of the donor who has already donated to the campaign. The donor engagement mechanism may allow donors to invite contacts from the micro-community to support a campaign that they have donated to. In some embodiments, the donor engagement mechanism may create and embed single or multiple hashtags for users to utilize to promote engaging and awareness on external social media networks. In some embodiments, donor engagement mechanism may capture and record donations so that a donor can view an image or depiction with an animated screen containing a user interface that captures, records and stores each donation amount to individual and collective campaigns over a certain time period. In addition, the donor may have the ability to send a special art asset to in support of the campaign organizer such as a “Hug, Heart, or Prayer”. These art assets may be clicked on the campaign organizers' individual account page so the proprietary algorithm may store the data from every campaign as to aggregate the total number of Hugs, Hearts and Prayers that have been sent during a day or period of time to that campaign organizer as well as in total on the Angelink platform.

In some embodiments, the algorithm may create a method to process each donation, and to reward the donor for each new donation with, for example, a perk or award. The awards may be based on the amount, frequency, repetition, among other things. In some embodiments, awards may be created via online certifications, or physical rewards that could be sent to the donor's address upon reaching certain levels. The online campaign donor engagement mechanism may be configured to be interactive and predictive, so that the system captures donor response to rewards, perks and offers and analyzes the information to create a donor fingerprint. The fingerprinting may be used as a method of measuring and combining data so that the donor's response to various rewards or perks creates a donor fingerprint that can be used to assist in future marketing and interaction with donor.

In some embodiments, the algorithm may combine data from the donor's age, gender, region or location, social media network, past giving history, with other items such as a donation theme or cause. The algorithm may be configured to formulate a method of interacting with the donor on the platform as well as other social media accounts. The algorithm may assist the system to create donor communities that have a common cause that are similar to that of the donor's past giving history.

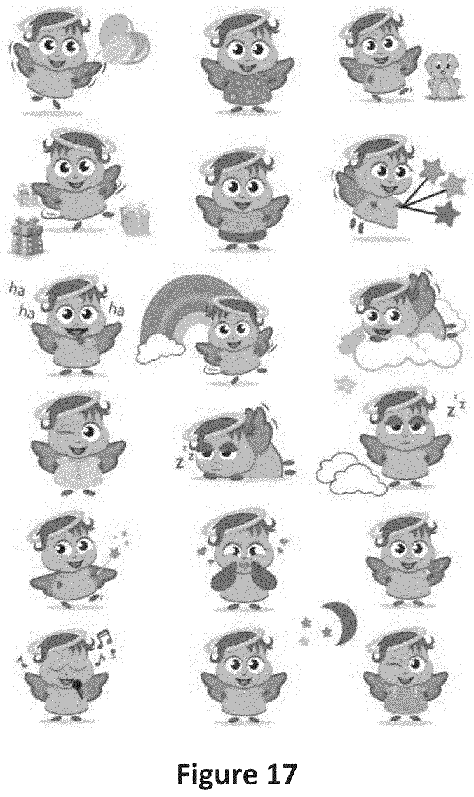

In some embodiments, the algorithm may analyze the information and populate a visual image or series of images to engage the donor, as illustrated in FIG. 5. The donor's fingerprint information may be used to create a user interface for each donor account page that hosts all donor information in order to reward the donor with special online perks. The online perks may be customizable based on user preferences. The online perks may include, but are not limited to, e-stickers, emoji, badges, rewards and achievements for each new donation. The online perks earned by the donor may be displayed on a graphical user interface (GUI). The GUI may comprise animated images, colorful images, still images, celebratory messages, congratulatory messages, or the like, to engage the donor. For example, the donor may be prompted to send a Happy Easter message with a proprietary Angelink Blue Angel emoji mascot character with an Easter Basket full or Easter eggs or a Happy Halloween with a Blue Angel emoji mascot character holding a pumpkin or a customized outfit or dress from a dataset provided to the donor. FIG. 17 illustrates some exemplary Angelink Blue Angel emoji mascot characters.

In some embodiments, the donor engagement mechanism may be configured to create a loyalty program that recognizes donors for their generosity and engages them in the platform. The recognition may encourage the donors to donate additional funds in order to achieve additional, higher rewards. The system may create custom donor pages or portals by employing data analysis and matching functionality.

In some embodiments, algorithms may be configured to sort donor information so that information can be highlighted throughout the platform to recognize donor's generosity and the rewards and prizes earned by the donor. The system may encourage friendly competition between donors and seeks to inspire donors on the platform to competitively donate more funds in order to achieve the same or higher level of recognition rewards, achievements or prizes of other competing donors. The data matching of donors to the same campaign may be displayed on a leaderboard so that every donor is recognized for their donation to this campaign and that the “winner” on the leaderboard is displayed as the donor who donated the highest amount of money as well as recognizing the donor who donated the highest amount of times to that particular campaign who may not have been donated the most amount of money to the campaign so that donors who give multiple times on the platform are “recognized and rewarded” for repeat engagement and repeat support of campaigns on the platform. In some embodiments, data security and encryption techniques such as blockchain technology may be employed to provide an immutable record for each campaign, campaign organizer, transaction and/or platform member.

In some embodiments, a method for incentivizing donating for a fundraising campaign may comprise identifying, by a computer-implemented algorithm, a fundraising campaign based on a donor input. Identifying a fundraising campaign for a donor may include determining a fundraising campaign suitable based on donor preferences. For example, a donor may wish to donate towards renovation of a faith-based institution or a place of worship. The algorithm may identify one or more suitable fundraising campaigns based on donor preferences to which the donor may donate.

The method may further comprise processing, by the computer-implemented algorithm, information associated with the donor input to validate a donor. Validating a donor may comprise verification of a plurality of donor credentials based on a comparison of the donor input and a database comprising information associated with the donor.

The method may further comprise, upon validating, sending, by the computer-implemented algorithm, to a user-device for display, a notification to grant access to the validated donor to donate to the identified fundraising campaign.

The method may further comprise processing, by the computer-implemented algorithm, a first monetary donation received from the donor, wherein the processing comprises updating, in real-time, a percentage completion value of a monetary goal of the fundraising campaign. The algorithm may be configured to receive and process the donation, and update in real-time a percentage of the monetary goal accomplished. In some embodiments, the algorithm may be configured to send a notification comprising information associated with an updated to the campaign organizer, donor, beneficiary, a campaign manager, or the like.

The method may further comprise sending, by the computer-implemented algorithm, to a user-device for display, a first indication of a receipt of a first reward based on the first monetary donation. The algorithm may be configured to send an indication of a receipt of a first reward to the donor upon donating and successful acceptance of the donation. The reward may comprise an art asset. In some embodiments, the donor may be initiate on a path to a rainbow in heaven. The path may include a game-like scheme to comprise nine cloud levels, such that the donor may be “on cloud nine” after donating nine times to the same fundraising campaign or making a total of nine donations to one or more different fundraising campaigns.

In some embodiments, the first and the second rewards may comprise an art asset comprising a static emoticon, an animated emoticon, an audio-visual emoticon, an interactive emoticon, text, or a combination thereof.

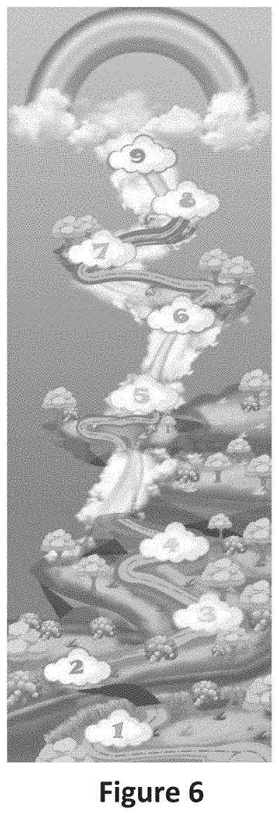

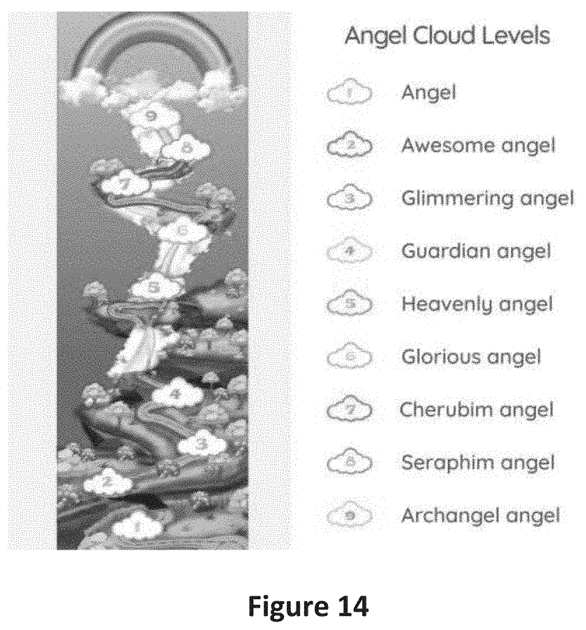

An illustrative example of a donor engagement mechanism is described herein. A woman makes a donation to a campaign on the platform with a $50 donation to a campaign organizer who is raising money for memorial/funeral expenses for her late spouse. After the donation is made and the transaction is processed, the system may display a donor user interface page that indicates that her $50 donation has earned her a perk and that she has won the award of being on the 1st “Cloud level” on a colorful, game-like Map to a rainbow in heaven, as illustrated in FIG. 6. The user interface may indicate that after completing all 9 cloud levels on the map she will “Earn Her Wings” and that she will become an “Angel Class 1” donor on the platform. The route to becoming the highest level (e.g., an Archangel) may include completing other cloud levels labeled as, for example, a Guardian Angel, Heavenly Angel, Glimmering Angel, Awesome Angel, Glorious Angel, Seraphim Angel, Cherubim Angel to eventually reach the final, highest level of the “Archangel,” as shown in FIG. 14. After the donor reaches all 9 cloud levels, the donor may be notified that he/she has reached the top-level achievement on the Map to Heaven and that he/she has attained the “Archangel” donor status on the platform. Upon obtaining the Archangel status, the donor may be sent additional perks including, but not limited to, awards via an online system, physical rewards to her address, customized plaques, medals, trophies, etc. Once the all 10 levels on the Map to Heaven have been achieved, the algorithm may generate a new game-like user interface such as a “Candy Land” map theme or a “Winter Wonderland” theme which may correspond to a season, theme or concept where the donor is rewarded with a different reward and perk system similar to the above that are based on the metrics and characteristics of the platform input. The gamification schemes may be configured to create an emotional connection between the campaign organizer and the donor or the beneficiary and the donor.

D. Campaign Organizer Engagement

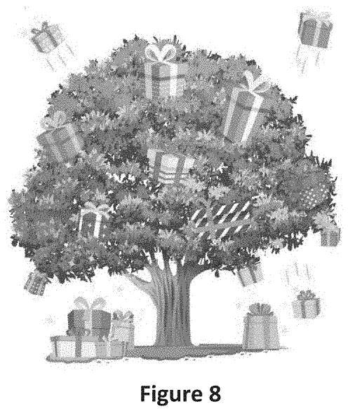

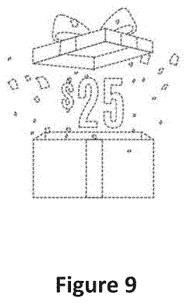

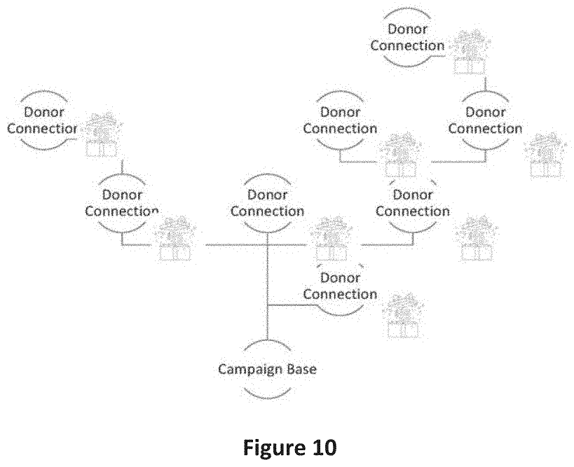

In some embodiments, a campaign organizer engagement mechanism may include capturing and recording donations to fundraising campaigns for the campaign organizer to review at a later time. For example, the campaign organizer may view an image or a depiction of each donation with an animated screen depicting these donations, as illustrated in FIG. 8. In some embodiments, visualizations may be customized based on the volume and/or amount of funds raised. Campaign organizer can view each donation amount during a period of time with a personal campaign organizer account page that depicts donations with a mapping technology. whereby donation amounts are shown as visual objects from an art asset library, as illustrated in FIG. 9. The donation may be unlocked or opened by the campaign organizer with the donation amount received on their personal account page. As the campaign grows, the visualization may expand and show additional animations in a way that builds incentives to continue to raise funds for the campaign, as illustrated in FIG. 10.

In some embodiments, a computer-implemented method for incentivizing raising donation for a fundraising campaign may comprise launching, by a computer-implemented algorithm, a fundraising campaign comprising a plurality of characteristics based on an input from a campaign organizer. The method for incentivizing raising donation may include gamification schemes, as described herein, for example. A fundraising campaign organizer or a beneficiary of the fundraising or crowdfunding campaign may launch or initiate a campaign. The fundraising campaign may include a plurality of characteristics such as, for example, a donation cause, a location, beneficiary profile including information associated with the beneficiary of the campaign. The beneficiary profile may include gender, age, marital status, employment status, medical information, among other personal information.

The method may further comprise determining, by the computer-implemented algorithm, a monetary goal for the fundraising campaign based on the plurality of characteristics. The algorithm may be configured to determine a monetary goal for the fundraising campaign based on one or more of donation cause, location and the beneficiary profile.

The method may further comprise sending, by the computer-implemented algorithm, to a user-device for display, a first indication of a receipt of a first reward for launching the fundraising campaign. To enhance campaign organizer engagement, the campaign organizer may be rewarded upon successfully launching a fundraising campaign. The algorithm may be configured to validate the fundraising campaign prior to launching the campaign on the platform. The validation may include verification of the plurality of characteristics including donation cause, location, personal information, veracity of the information provided by a campaign organizer or the beneficiary, among other factors. The algorithm may be further configured to send a first indication of the receipt of the reward to the campaign organizer or the beneficiary, or both. The indication may be sent to a user-device including, but is not limited to, a mobile phone, a laptop, a computer, a tablet, or any other device capable of displaying messages. The indication may include a textual message, an audio message, an audio-visual message, or a combination thereof, or any other suitable messaging mechanism.

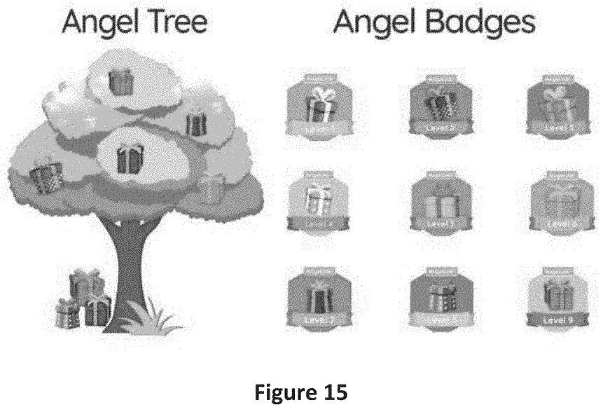

The method may further comprise sending, by the computer-implemented algorithm, to the user-device for display, a notification of a receipt of a donation from a donor, the notification comprising information associated with the donation. The campaign organizer may receive a notification upon receipt of a first donation from a donor. The donation notification may include an art asset including a gift box, a donation value, a badge, a donation tree, gift-boxes falling from a tree (as shown in FIG. 15) donor information such as, for example, a photograph, contact information, gender, age, location, and the like.

The method may further comprise determining, by the computer-implemented algorithm, a percentage of the monetary goal accomplished based on the received donation and sending to the user-device for display, a second indication of a receipt of a second reward upon accomplishing a first percentage of the monetary goal. The algorithm may be configured to determine a percentage of the monetary goal accomplished and send indication(s) to the user-device notifying the percentage of the monetary goal accomplished and receipt of a second reward. For example, algorithm may determine when 10%, 20%, 30%, 40%, 50%, 60%, 70%, 80%, 90%, or 100% of the monetary goal may be accomplished through donations to the fundraising campaign. In some embodiments, the algorithm may be configured to determine and indicate to the campaign organizer upon accomplishing 20%, 40%, 60%, 80%, or 100% of the monetary goal. It is appreciated that algorithm may be configured to determine any percentage and percentage intervals of monetary goal for the fundraising campaign.

The method may further comprise sending, by the computer-implemented algorithm, to the user-device for display, a third indication of a receipt of a third reward upon accomplishing the monetary goal. In some embodiments, the algorithm may be further configured to send an indication of a receipt of a reward upon successfully accomplishing 100% of the monetary goal, or more than 100%.

In some embodiments, the method may comprise determining, using a computer-implemented algorithm, a time-period associated with the monetary goal for the fundraising campaign. The time-period may be based on donation cause, for example.

The method may further comprise assigning, by the campaign organizer, an art asset representing the fundraising campaign, wherein the art asset comprises a static emoticon, an animated emoticon, an audio-visual emoticon, an interactive emoticon, text, or a combination thereof.

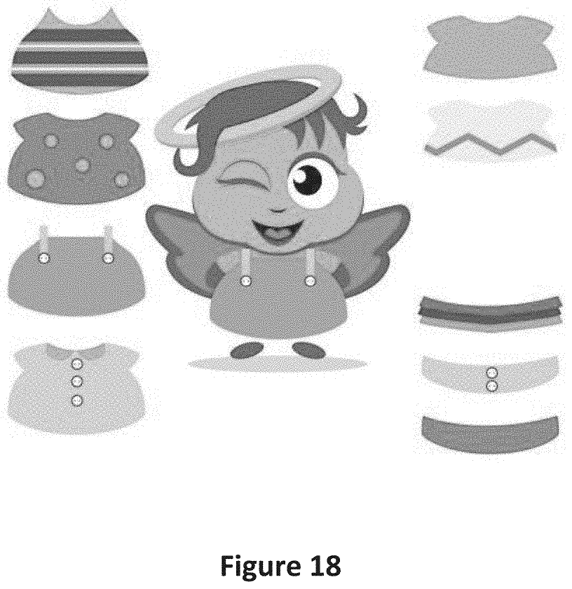

In some embodiments, a campaign organizer engagement mechanism may create and embed single or multiple hashtags for users to utilize to promote engagement and awareness on external social media networks. In some embodiments, the campaign organizer engagement mechanism may capture and record donations so that a campaign organizer with a personal campaign can view, for example, an image or a depiction with an animated screen containing a user interface that captures records and stores each donation “gift” amount to their personal campaign or a campaign they started for someone else. For example, the campaign organizer may be prompted to send a Blue Angel emoji mascot character and choose art assets to accompany or “dress or provide a costume” for the Angel or character. Such as a pink dress, white shirt and green shorts and/or a birthday hat to customize and personalize so that it is unique and customized as selected from a pre-determined set of art assets so that each campaign organizer has the opportunity to customize their fundraising campaign. FIG. 18 illustrates exemplary art assets including costumes and dresses for a Blue Angel emoji mascot character.

In some embodiments, the algorithm may create a method to process each donation gift with an animated or non-animated colorful image that the campaign organizer can view with a customized GUI based on data such as, whether the campaign is a personal fundraising initiative or a fundraising campaign initiated to benefit another individual or charity, donation theme, or campaign cause. In some embodiments, data security and encryption techniques such as blockchain technology may be employed to provide an immutable record for each campaign, campaign organizer, transaction and/or platform member.

An illustrative example of the campaign organizer engagement mechanism is described herein. A woman is notified that she has received a $75 donation to her personal fundraising campaign that she launched for a new roof for her home that was damaged in a recent hurricane. She is provided a custom user interface depicting an “Angel Tree” concept with a colorful, animated gift box that is “sparkling” or “shining” that prompts the campaign organizer to “open her gift box” in order to see the amount that has been donated to her campaign. When she clicks on the “gift/present” the box opens to reveal a $75 gift from a donor. The artistic depictions may also contain the name of the Donor and/or a photograph of the Donor as well as other data. The campaign organizer will continue to be notified of incoming donations. The campaign organizer may click to open gift boxes to reveal donations to her campaign as they are donated over time.

In some embodiments, the campaign organizer engagement mechanism may include filling the first Angel Tree with a total of, for example, 10 gift boxes. In some embodiments, the total number of gift boxes depicted on a tree may be determined by an algorithm, based on factors such as amount, frequency, time of the year, etc. One or more Angel Trees may appear on the GUI with different colorful artwork and game-like “Forest Map of Angel Trees” based on the number of donations received. A further example of the notification system may employ a Blue Angel emoji mascot character “notifies” the campaign organizer whether by animated or non-animated art assets that she has received 10 donations to her campaign during the last 24 hour period as a form or notification and engagement to serve as a reminder for the campaign organizer to login and re-engage with the platform in order to review the status of her campaign fundraising efforts.

E. “Angels Among Us”—Concept Recognizing, Rewarding and Incentivizing Campaign Organizers Who Launch Campaigns for Someone Else and do not directly benefit from a campaign

“Angels Among Us” may comprise a loyalty program, configured to allow a campaign organizer to launch one or more crowdfunding campaigns and raise funds on behalf of someone else and do not directly benefit from the campaign. The algorithm may be configured to collect information from the campaign and identify the campaign as a special campaign based on the collected information. The technology will create a system of rewards that recognizes her fundraising efforts for someone else and she will also be recognized on the platform as a member of the Angelink community called “Angels Among Us.”

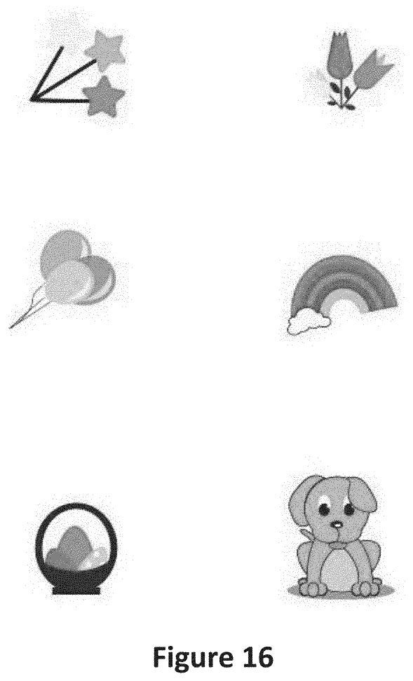

In some embodiments, an algorithm may be configured to capture data based on the number of campaigns she launches overtime by donation theme, campaign cause, category, location, percentage of goal complete, funding velocity, as well as other factors. The campaign organizer may be given special rewards, perks and recognition by online notifications and/or physical rewards as she attains a higher “Angel Among Us” level based on the increasing amount of funds raised and/or the number of donations she has obtained for her campaign or multiple campaigns. The system may create and embed single or multiple hashtags for users to utilize to promote engagement and awareness on external social media networks. The “Angels Among Us” community may have unique game-like user interfaces that may comprise artwork such as angel characters, angel animations with stars, moons, and rainbows, angel animals, or other art assets, as illustrated in FIG. 16. For example, the campaign organizer may be able to further customize a Blue Angel emoji mascot character and choose art assets to accompany or “dress or provide a costume” for the Angel or character as well as upload a logo or design to add to the mascot's dress or as a flag or banner for example so that the mascot is further customized to that particular campaign to represent the community organization for which the campaign is raising funds. For example, if Jane wanted to establish a campaign to benefit the local homeless shelter in Brooklyn, N.Y. she could upload and embed the logo of this homeless shelter on to a yellow shirt that she choose from a pre-determined dataset establish of mascot “clothes and outfits” and choose purple shoes and a pink bow so that this character could be established as a customized emoji to represent this campaign that benefits the particular homeless shelter in Brooklyn, N.Y. The campaign organizer may also earn online rewards, perks and achievements as well as other physical awards that may be sent or shipped as the campaign reaches a higher percentage completion to recognize and promote her status within the special category. In some embodiments, data security and encryption techniques such as blockchain technology may be employed to provide an immutable record for each campaign, campaign organizer, transaction and/or platform member.

An illustrative example of Angels Among Us program is described herein. A young woman in New York (or any other state or region or country) may start a campaign for a homeless family who needs financial help. Because she is raising funds for someone else the algorithm may identify donors in local communities, or neighboring regions. The identified donors or potential donors may be notified, for example, via email, message, regular mail, text, phone call, or the like. Other local people in New York or surrounding areas who are within the user community or other Angelink partner communities may be contacted to help the campaign organizer publicize her campaign and/or raise awareness. The algorithm may also analyze and asses total number of users, for example, within the Angels Among Us—New York region, donors to previous Angel Among Us campaigns, campaign organizers, and determine additional charitable organizations in the New York area who may have an unmet need for financial help or volunteer, mentorship or other types of help to promote these causes on the Angels Among Us—New York Community. For example, she may be able to establish a “giving circle” community to benefit a select number of charities in New York city and establish pre-determined charities to become beneficiaries of her “giving circle” community that may be protected with specific rules for data security and encryption techniques such as blockchain technology may be employed to provide an immutable record for each campaign, transaction and community member of the particular “giving circle”.

Occasionally, Angelink may hold conferences and host events to honor the donors or campaign organizers in the Angels Among Us category. The algorithm may determine a group of women who may be invited to the events based on a number of factors, including but not limited to, donor activity, past giving history, volunteering activity, trusted relationship, etc. The algorithm may correlate and calculate data to determine a group of women who have donated a certain dollar amount to one or more campaigns and/or made multiple donations of smaller amounts to New York city campaigns or created a campaign that benefited the New York region based on input data.

In some embodiments, the algorithm may be configured to recommend the user group that constitutes the Angel Among Us New York group to ensure that only the trusted users are invited to the Angels Among Us New York host events such as, an award dinner, a luncheon with motivational speakers or leaders, a seminar, a retreat, a conference, etc.

F. Joint Donor and Campaign Organizer Engagement

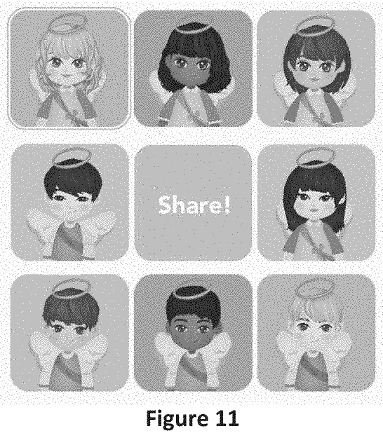

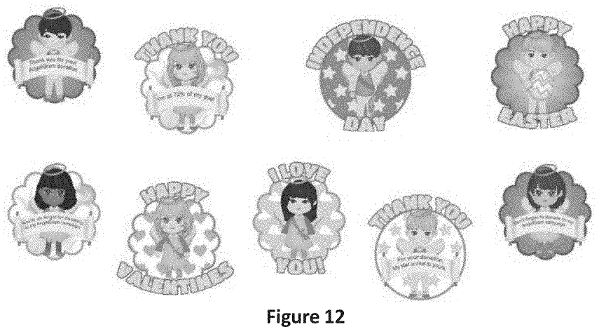

In some embodiments, a joint donor and campaign organizer engagement mechanism may include creating and providing a comprehensive database of animated art assets and non-animated art assets including, but not limited to, characters, emojis, e-stickers, badges, colorful images that may include art asset such as a Blue Angel mascot emoji character that may be customized and personalized as described above and/or a special emoji character that may depict a human, angel, pet, animals, etc. FIG. 11 illustrates exemplary customizable, non-animated art assets, and FIG. 12 illustrates exemplary customizable, animated art assets. The campaign organizers can combine one or more of the art assets with celebratory messages, congratulatory messages, condolence messages, support messages, etc. In some embodiments, the campaign organizers may send messages, texts, emails, alert messages, update messages, status update messages and other messages directly to the campaign organizer and/or donor to enhance engagement, community building and repeat giving on the platform.

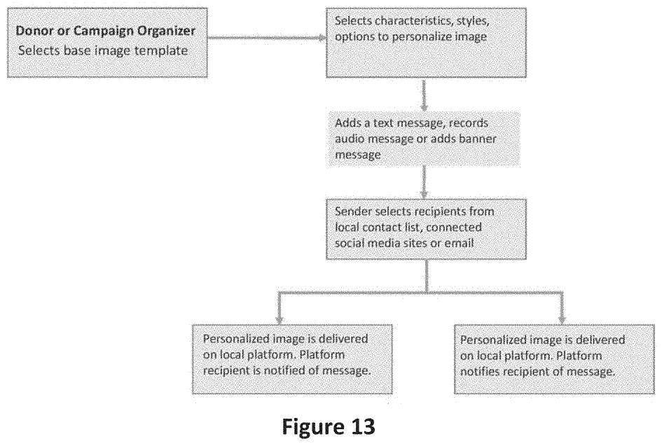

As illustrated in FIG. 13, donors can use one or more of the art assets from the database to send messages including, but not limited to, good luck messages, wishes, encouragement messages, empathy messages, compassion messages, or the like. The donor may share a story from their own experience to build a more direct connection with the campaign organizer. The art assets may be stored in a database of art assets. The database may be accessible to donors, campaign organizers, members, campaign managers, trusted connections, etc. In some embodiments, access to the database may be granted upon identification verification such as, a password, a donor ID, a multi-factor authentication password, one-time password, etc.

In some embodiments, the art assets may be customizable by both the campaign organizer and the donor. Customizations may include, but are not limited to, changes to hair color, hair style, facial expressions, eye color, facial positioning, skin color, textures, placements, inclusion of ornamental accessories (i.e., customized logo, jewelry, makeup, etc.) and visualization of a customized message simulating the speaking of the written message to the recipient.

An illustrative example of the joint donor-campaign organizer engagement is described herein. A campaign organizer who has launched her personal fundraising campaign may utilize the art assets to promote the campaign. The campaign organizer and/or donor may share the art assets with friends and family on social media networks. In some embodiments, the campaign organizer may utilize the art assets to promote and market a new campaign.

In some embodiments, if the campaign becomes stagnant or non-efficient in raising funds, the campaign organizer may send a custom Angelink message via text, chat, email, in-app messaging, etc. to her social media contact list to reenergize her campaign. The algorithm may determine the “health” of a campaign based on a velocity of donations, amount of donations, frequency of donations, number of donors visiting the campaign site, percentage goal accomplished, time remaining to achieve the goal, etc. In some embodiments, the algorithm may generate a health score based on the determination of the overall health of the campaign. In some embodiments, the health score may be used internally to trigger various events, reports, actions, etc. In some embodiments, data security and encryption techniques such as blockchain technology may be employed to provide an immutable record for each campaign, campaign organizer, transaction and/or platform member. An example of this may be that the Blue Angel mascot character may be sent by the campaign organizer with a customized message such as “please don't forget to donate to my campaign as I'm 39% of my goal and need your help to reach my financing goal”. Another example may be that this Blue Angel mascot emoji character is sent by the donor in support of the campaign organizer with a special heart, or rainbow art asset that the donor can message to inspire and uplift the campaign organizer.

In some embodiments, the message may comprise a customizable, animated angel characteristic. The campaign organizer may be allowed to select hair color, eye color, angel dress and wing color or style, or seasons objects that the angel may hold such as a Valentine Heart, an Easter Basket, Halloween Pumpkin, Christmas Tree, gifts, presents, or the like. The campaign organizer may also choose from a select grouping of messages that the algorithm suggests based on the campaign characteristics such as, “Please help—Be an Angel” or “Don't forget me this Mother's Day.” The campaign organizer may utilize these engagement tools to promote and market their campaign as well as to send thank you and personalized messages directly to a donor, a group of donors, a potential donor, or a potential group of donors. Similarly, the donor may utilize these art assets in order to further communicate, inspire or uplift the campaign organizer.

In some embodiments, the campaign organizer may use these engagement tools to promote her personal, group and/or charitable fundraising campaign in order to obtain more donations and to highlight features, attributes, causes or issues relating to her campaign or a group of campaigns. Donors may use these engagement tools to also promote campaign they have donated to and to draw attention to other personal, group and/or charitable fundraising campaigns that they want to share among their friends and family. The engagement tools may be transmitted and/or posted to other social media platforms and shared within micro-communities of donors and campaign organizers. Similarly, a donor may utilize the Angelink customizable angel characters in the form of e-stickers, emojis, or animated characters with customizable art assets, and personalized messages to send uplifting messages or messages of compassion to campaign organizers or within micro communities that have been suggested by the algorithm.

1. A computer-implemented method for managing a fundraising campaign, the method comprising:
launching a first fundraising campaign comprising a first plurality of characteristics;
determining, by a computer-implemented algorithm, a surplus amount of monetary donation towards the first fundraising campaign based on a monetary goal associated with the fundraising campaign;
identifying, by the computer-implemented algorithm, a plurality of a different set of fundraising campaigns, each fundraising campaign of the plurality of the different set of fundraising campaigns comprising a second plurality of characteristics, wherein at least one characteristic of the first and the second plurality of characteristics is similar;
upon identifying, determining, by the computer-implemented algorithm, a portion of the surplus amount to be distributed to the identified plurality of the different set of fundraising campaigns, the portion based on a pro-rata distribution mechanism;
generating, by the computer-implemented algorithm, a recommendation for a donor to the first fundraising campaign, to donate to one or more of the identified plurality of the different set of fundraising campaigns based on the determination of the portion of the surplus amount; and
sending, by the computer-implemented algorithm, instructions to a user-device to cause the user-device to display the recommendation and a donation request notification for the donor.

2. The method of claim 1, wherein each of the first and the second plurality of characteristics comprises a donation cause, a beneficiary profile, or a location of a beneficiary of a corresponding fundraising campaign.

3. The method of claim 2, wherein the donation cause comprises a medical, a memorial, an emergency, an education, a volunteer, a charity, a team, a sport, a pet, an animal, a faith, a friend, a family, or a community cause.

4. The method of claim 2, wherein the beneficiary profile comprises information associated with a gender, age, marital status, or employment status of the beneficiary.

5. The method of claim 2, wherein the beneficiary comprises an individual or a group of individuals, and wherein a relationship between a donor and the beneficiary comprises a trusted connection or a non-trusted connection.

6. The method of claim 2, wherein identifying the plurality of fundraising campaigns further comprises comparing the donation cause and the location of the beneficiary of the first fundraising campaign and the plurality of the different set of fundraising campaigns.

7. The method of claim 6, wherein identifying the plurality of fundraising campaigns further comprises comparing the donation cause, the location of the beneficiary, and the beneficiary profile of the first fundraising campaign and the plurality of the different set of fundraising campaigns.

8. The method of claim 7, wherein identifying the plurality of fundraising campaigns further comprises comparing a completion status of the identified plurality of the different set of fundraising campaigns.

9. The method of claim 1, wherein the portion of the surplus amount comprises a threshold amount, the threshold amount predetermined by a campaign organizer of a fundraising campaign of the identified plurality of the different set of fundraising campaigns.

10. The method of claim 1, further comprises distributing the surplus amount among the identified plurality of the different set of fundraising campaigns using the pro-rata distribution mechanism, wherein the pro-rata distribution mechanism comprises a predetermined percentage-based distribution.

11-20. (canceled)
